(19) United States
(12) Patent Application Publication
(10) Pub. No.: US 2022/0351223 A1
(43) Pub. Date: Nov. 3, 2022

(54) SYSTEM AND METHOD FOR PREDICTING PRICES FOR COMMODITIES IN A COMPUTING ENVIRONMENT

(71) Applicants: MOURI Tech LLC, Coppell, TX (US); AI RANDOMTREES LLC, Houston, TX (US)

(72) Inventors: Pavan K. Vankadaru, Tomball, TX (US); Anil R. Yerramreddy, Irving, TX (US)

(73) Assignees: MOURI Tech LLC; AI RANDOMTREES LLC

(21) Appl. No.: 17/246,962

(22) Filed: May 3, 2021

(51) Int. Cl. G06Q 30/02; G06Q 10/06; G06N 5/02; G06N 20/00

(52) U.S. Cl. CPC G06Q 30/0206; G06Q 30/0205; G06Q 10/067; G06Q 30/0201; G06N 5/02; G06N 20/00; G06Q 50/26

(57) ABSTRACT

A system and method for predicting prices for commodities in a computing environment is disclosed. The method includes obtaining supply chain attributes associated with a product from internal and external data sources. The method further includes predicting current demand value of the product based on the supply chain attributes using artificial intelligence-based models. Further, generating an optimum price value for the product based on the current demand value. Additionally, computing average price value at a regional level for the product based on regional product information retrieved from one or more local authority databases using artificial intelligence-based models. The method further includes determining a best suitable price value. Also, simulating the best suitable price value for the product in a simulation environment using one or more artificial intelligence-based models. Furthermore, the method includes generating a final price value.

### FIELD OF INVENTION

Embodiments of a present disclosure relate to cloud computing systems and more particularly to a system and a method for predicting prices for commodities such as dairy products in a computing environment.

### BACKGROUND

For businesses, prices of various products need to be set. These prices may be set with the goal of maximizing profit or demand or for a variety of other objectives. Traditionally, price-setting may be performed by experienced business managers in comparison to competitors' pricing to maintain sales goals or through complex price optimization systems. For pricing optimization systems, there may be a variety of factors considered for the generation of demand models. Additionally, costs may be fixed or variable and may be dependent on demand. As a result, the function for forecasting prices may be very complex. For a chain of stores with tens of thousands of different products, forecasting prices and determining a function for forecasting demand are difficult.

Currently, benefits analysis may be performed manually by comparing previous sales data with current sales data. However, such a general approach does not accurately identify benefit sources or account for additional variables such as seasonality and promotional effects. As such, current benefits methodologies are highly subjective and rely upon inaccurate comparisons. Such benefits analyses are wholly inadequate to base business decisions upon as they do not correctly characterize price optimization benefits. For the typical business, the above-mentioned systems are still too inaccurate, unreliable, and intractable in order to be utilized effectively for benefits analysis related to price optimization. Businesses, particularly those involving large product sets, would benefit greatly from the ability to have accurate benefits analysis.

Hence, there is a need for an improved system and a method for accurately predicting prices during recurring events in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a system for predicting prices for commodities in a computing environment is disclosed. The system includes one or more hardware processors and a memory coupled to the one or more hardware processors. The memory includes a plurality of subsystems in the form of programmable instructions executable by the one or more hardware processors. The plurality of subsystems includes a supply chain attribute collection subsystem configured for obtaining one or more supply chain attributes associated with a product from one or more internal and external data sources. The plurality of subsystem further includes a demand value prediction subsystem configured for predicting current demand value of the product based on the obtained one or more supply chain attributes using one or more artificial intelligence-based models. Furthermore, the plurality of subsystem includes an optimum price value generator subsystem configured for generating an optimum price value for the product based on the predicted current demand value. Further, the plurality of subsystem includes an average price value computing subsystem configured for computing an average price value at a regional level for the product based on regional product information retrieved from one or more local authority databases using one or more artificial intelligence-based models. Also, the plurality of subsystem includes a best suitable price determination subsystem configured for determining a best suitable price value for the product by analyzing the generated optimum price value, the computed average price value and a competitor's price value for the product. Also, the plurality of subsystem include a simulation subsystem configured for simulating the determined best suitable price value for the product in a simulation environment using one or more artificial intelligence-based models. Additionally, the plurality of subsystem includes a final price generator subsystem configured for generating a final price value for the product based on the results of the simulation subsystem, wherein the final price value is the simulated best suitable price value of the product. Moreover, the plurality of subsystem includes an output subsystem configured for outputting the generated final price value for the product on a user interface of a user device.

In accordance with another embodiment of the present disclosure, a method for predicting prices for commodities in a computing environment is disclosed. The method includes obtaining one or more supply chain attributes associated with a product from one or more internal and external data sources. The method further includes predicting current demand value of the product based on the obtained one or more supply chain attributes using one or more artificial intelligence-based models. Further, the method includes generating an optimum price value for the product based on the predicted current demand value. Additionally, the method includes computing an average price value at a regional level for the product based on regional product information retrieved from one or more local authority databases using one or more artificial intelligence-based models. The method further includes determining a best suitable price value for the product by analyzing the generated optimum price value, the computed average price value and a competitor's price value for the product. Also, the method includes simulating the determined best suitable price value for the product in a simulation environment using one or more artificial intelligence-based models. Furthermore, the method includes generating a final price value for the product based on the results of the simulation subsystem. The final price value is the simulated best suitable price value of the product. Also, the method includes outputting the generated final price value for the product on a user interface of a user device.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for predicting prices for commodities in accordance with an embodiment of the present disclosure;

FIG. 2A is a process flow diagram illustrating an exemplary method of decision tree implementation for predicting prices for commodities in accordance with an embodiment of the present disclosure;

FIG. 2B is a process flow diagram illustrating an exemplary method of random forest implementation for predicting prices for commodities in accordance with an embodiment of the present disclosure;

FIG. 3 is a process flow diagram illustrating an exemplary method of high-level image processing using convolution layers in accordance with an embodiment of the present disclosure;

FIG. 4 is a process flow diagram illustrating an exemplary method for predicting prices for commodities in accordance with an embodiment of the present disclosure;

FIG. 5 is a process flow diagram illustrating an exemplary method for determining best suitable price of the product in accordance with an embodiment of the present disclosure; and

FIG. 6 is a snapshot view of an exemplary graphical user interface depicting a launch page of the software application, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Throughout this document, the terms browser and browser application may be used interchangeably to mean the same thing. In some aspects, the terms web application and web app may be used interchangeably to refer to an application, including metadata, that is installed in a browser application. In some aspects, the terms web application and web app may be used interchangeably to refer to a website and/or application to which access is provided over a network (e.g., the Internet) under a specific profile (e.g., a website that provides email service to a user under a specific profile). The terms extension application, web extension, web extension application, extension app and extension may be used interchangeably to refer to a bundle of files that are installed in the browser application to add functionality to the browser application. In some aspects, the term application, when used by itself without modifiers, may be used to refer to, but is not limited to, a web application and/or an extension application that is installed or is to be installed in the browser application.

Embodiments of the present disclosure disclose a system and method for predicting prices for commodities in a computing environment. The present invention is of a system and method to set prices for food products which are typically impacted by many variables. The system helps in setting prices intelligently i.e., neither too high nor too low. The system helps in finding the right trade-offs between multiple variables of demand & supply, customer behavior, and competitor price setting behaviors. The system provides a data-driven approach and brings all the information that a pricing manager would need to make an informed and intelligent decision quickly. The system consists of an AI engine module configured to process various input parameters related to the product and to determine an optimal price of the product.

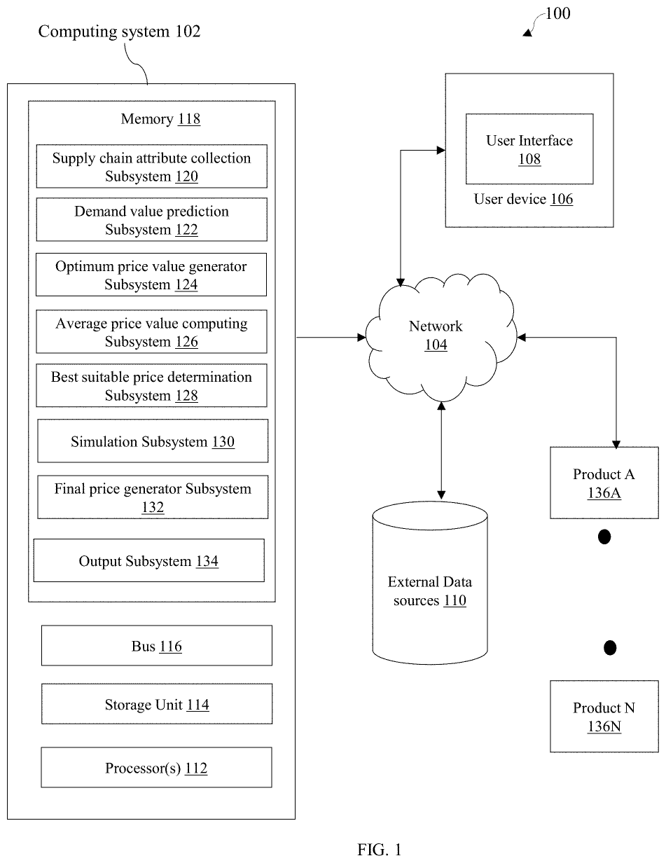

Referring now to the drawings, and more particularly to FIGS. 1 through 6, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for predicting prices for commodities in accordance with an embodiment of the present disclosure. According to FIG. 1, the computing environment 100 comprises a computing system 102 which is capable of delivering software applications for managing pricing systems of dairy-related products 136A-N. The commodities may be the dairy-related products 136A-N which are saleable. In the present embodiment, dairy-related products 136A-N represent dairy or dairy-related products that include, but are not limited to, milk, butter, cheese, cream, and other dairy-based commodities. According to some embodiments, the products 136A-N may be any food product or any human consumable product. In another embodiment, the product may be a software product such as software application sold on internet. In another embodiment, the products 136A-N may be a hardware product such as any apparatus, machine, vehicle, or device.

The computing system 102 is connected to a software application in the user device 106 via a network 104 (e.g., Internet). In one specific embodiment, the one or more communication networks 104 may include, but not limited to, an internet connection, a wireless fidelity (WI-FI) and the like. Although, FIG. 1 illustrates the computing system 102 connected to one user device 106, one skilled in the art can envision that the computing system 102 can be connected to several user devices located at different locations via the network 104.

The user devices 106 can be a laptop computer, desktop computer, tablet computer, smartphone and the like. The user device 106 can access cloud applications via a web browser. The user device 106 includes a user interface 108 for managing the software application for predicting prices for commodities. The software application may be a web application including one or more web pages.

The computing system 102 includes a processor 112, a database 114, and a memory 118. The processor 112, and the memory 114, may be communicatively coupled by a system bus such as a system bus 116 or a similar mechanism. The computing system 102 further includes an interface, a server including hardware assets and an operating system (OS), a network interface, and application program interfaces (APIs). The interface enables communication between the server and the user device 106. As used herein, “computing environment” refers to a processing environment comprising configurable computing physical and logical assets, for example, networks, servers, storage, applications, services, etc., and data distributed over the platform. The computing environment 100 provides on-demand network access to a shared pool of the configurable computing physical and logical assets. The server may include one or more servers on which the OS is installed. The servers may comprise one or more processors, one or more storage devices, such as, memory units, for storing data and machine-readable instructions for example, applications and application programming interfaces (APIs), and other peripherals required for providing cloud computing functionality.

The processor(s) 112, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The processor(s) 112 may also include embedded controllers, such as generic or programmable logic devices or arrays, application specific integrated circuits, single-chip computers, and the like. The computing system 102 may be a cloud computing system or a remote server.

The memory 118 may be non-transitory volatile memory and non-volatile memory. The memory 118 may be coupled for communication with the processor(s) 112, such as being a computer-readable storage medium. The processor(s) 112 may execute machine-readable instructions and/or source code stored in the memory 118. A variety of machine-readable instructions may be stored in and accessed from the memory 118. The memory 118 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 118 includes a plurality of subsystems stored in the form of machine-readable instructions on any of the above-mentioned storage media and may be in communication with and executed by the processor(s) 112.

The memory 118 includes a plurality of subsystems in the form of programmable instructions executable by the one or more hardware processors 112. The plurality of subsystems includes supply chain attribute collection subsystem 120 configured for obtaining one or more supply chain attributes associated with a dairy-related products 136A-N from one or more internal and external data sources 110, and 114. The supply chain attributes comprises historical store demand, historical store prices, holidays, local events, store traffic, customer buying trends and the like. The one or more internal data sources 110, may be the storage unit 114. The one or more external data sources 114 may be external data source 110. The dairy-related products 136A-N may be any food, or human consumable item. In another embodiment, the dairy-related products 136A-N may be any software or hardware product related to a company. For example, the dairy-related products 136A-N may be a software application, or a hardware device or apparatus.

Continuing with FIG. 1, the plurality of subsystem further includes a demand value prediction subsystem 122 configured for predicting current demand value of the dairy-related products 136A-N based on the obtained one or more supply chain attributes using one or more artificial intelligence-based models. The current demand value may be determined at a local store level. In predicting the current demand value of the dairy-related products 136A-N based on the obtained one or more supply chain attributes using the one or more artificial intelligence-based models, the demand value prediction subsystem 122 is configured for classifying the one or more supply chain attributes based on the content and type of the one or more supply chain attributes. The one or more supply chain attributes may be classified as one or more of supply related information, demand related information, transportation information, process, storage information, finance information, and environment information.

The supply chain attributes may include, but are not limited to, historical sales data (such as volumes and prices) from internal systems, weather, local events, gasoline prices, store level inventories, supply chain inventories, expiry dates, shelf life, new products, and the like. The demand value prediction subsystem 122 is further configured for generating a supply chain artificial intelligence model based on the classified one or more supply chain attributes. The supply chain artificial intelligence model represents a correlation between each of the one or more supply chain attributes. A Random Forest (RF) regressor or a decision tree-based artificial intelligence model may be used for this purpose. According to some embodiments, RF Regression is a supervised learning algorithm that uses ensemble learning method for regression. A RF operates by constructing several decision trees during training time and outputting the mean of the classes as the prediction of all the decision trees.

Further, the demand value prediction subsystem 122 is configured for predicting the current demand value of the dairy-related products 136A-N based on the generated supply chain artificial intelligence model. Demand is predicted by establishing the store demand as the target variable and also identifying all the independent variables that influence the target variable. Some of the independent variables in this context are historical sales data (volumes, prices) data from internal systems, weather, local events, gasoline prices, store level inventories, supply chain inventories, expiry dates, shelf life, new products, and the like. In many instances, the RF regressor provides a higher degree of forecast accuracy for the data set.

For example, the model provides a current demand score for the dairy-related products 136A-N by analyzing the relationships between the one or more supply chain attributes. The decision tree and the RF regressor considers the following selected features as inputs that have proven to have strong correlations with the outputs. These correlations are validated by the respective subject matter experts. Examples of inputs include, but are not limited to:

Internal Data: Data that is available within the organization's system such as:
Sale volume
Dates of sales
Per unit price
Store stocks
Wholesale stocks
Product expiration dates

External Data: Data fetched from outside the organization such as:
Average temperature
Humidity
Gas prices
Unemployment rate
Dollar exchange rate
Number of stores
Number of schools
Population rate
Retail disposable income
Traffic

The above data is fed to (A) Decision trees and (B) RF regressors to predict the following outputs: demand (volumes) prediction for products and price prediction for products.

Continuing with FIG. 1, the plurality of subsystems further includes an optimum price value generator subsystem 124 configured for generating an optimum price value for the dairy-related products 136A-N based on the predicted current demand value. The optimum price value is the optimum price is defined as price point where revenue is maximized without any adverse impact on demand or demand erosion. Typically, the optimum price has price elasticity of “one”. Price elasticity of demand is the variation in demand in response to a variation in price. While it is difficult to achieve a perfect optimum price, it is often used as a reference price point for comparison.

In generating the optimum price value for the dairy-related products 136A-N based on the predicted current demand value, the optimum price value generator subsystem 124 is configured for determining product market analysis data associated with the product based on the predicted demand value. The product market analysis data comprises at least one of macroeconomics data, microeconomics data, environmental data, customer base data, event occurrence data, financial data, transactional data, demographics data, local authority data, and market promotional data. Macroeconomics data includes unemployment levels, producer price index, inflation, dollar exchange rates, microeconomics factors to include gasoline prices, competitor promotions, and demographics to include the number of restaurants, population increases, schools opened, stores opened, and the like.

Further, the optimum price value generator subsystem 124 is configured for computing a product price elasticity value for the dairy-related products 136A-N based on the determined product market analysis data. The product price elasticity value is a measure of how sensitive the quantity demanded of the product is to its price. The product elasticity value may be computed through any known mechanisms. The optimum price is the price at which revenue is maximized when the price is set so that the elasticity is exactly equal to one. The formula for coefficient of price elasticity is e(p)=(dq/q)/dp/p, where p is the price of the demanded good and q is the quantity of the demanded good.

The variation in demand in response to a variation in price is called price elasticity of demand. It may also be defined as the ratio of the percentage change in quantity demanded to the percentage change in price of particular commodity. In other words, the price elasticity of demand is the change in demand for a commodity due to a given change in the price of that commodity. The optimum price value generator subsystem 124 is configured for generating optimum price value for the dairy-related products 136A-N based on the computed product elasticity value for the dairy-related products 136A-N.

The plurality of subsystem further includes an average price value computing subsystem 126 configured for computing an average price value at a regional level for the dairy-related products 136A-N based on regional product information retrieved from one or more local authority databases using one or more artificial intelligence-based models. The average price value at a regional level may be derived using USDA promotions as per region, USDA weight average price as per region, and USDA lowest to highest price range. The local authorities, such as USDA maintain a database comprising the USDA promotions as per region, USDA weight average price as per region, and USDA lowest to highest price range. The local authorities provide a guidelines to these prices on region basis for every product type. In computing the average price value at a regional level for the dairy-related products 136A-N based on regional product information retrieved from one or more local authority databases using one or more artificial intelligence-based models, the average price value computing subsystem 126 is configured for retrieving regional product information associated with the product from one or more local authority databases, such as external databases 110.

The regional product information comprises market promotional data, and net average price of the dairy-related products 136A-N as directed by the local authority guidelines. For example, the regional product information comprises USDA promotions as per region, USDA weight average price as per region, and USDA lowest to highest price range. Further, the average price value computing subsystem 126 is configured for generating an artificial intelligence based regional price model based on the retrieved regional product information. The generated artificial intelligence based regional price model represents a correlation between each of the regional product information associated with the dairy-related products 136A-N. A RF regressor or a decision tree type of artificial intelligence model may be used for this purpose. The average price value computing subsystem 126 is configured for computing the average price value at a regional level for the dairy-related products 136A-N based on the generated artificial intelligence based regional price model. Average values are published by USDA. The methods disclosed herein uses the history of average values to predict what the regional average value can be. For example, the artificial intelligence based regional price model provides an average price score for the dairy-related products 136A-N by analyzing the relationships between the regional product information.

The plurality of subsystems further includes a best suitable price determination subsystem 128 configured for determining a best suitable price value for the dairy-related products 136A-N by analysing the generated optimum price value, the computed average price value and a competitor's price value for the dairy-related products 136A-N. in determining a best suitable price value for the dairy-related products 136A-N by analysing the generated optimum price value, the computed average price value and the competitor's price value for the dairy-related products 136A-N, the best suitable price determination subsystem 128 is configured for obtaining the competitor's price value for the dairy-related products 136A-N from one or more data sources, such as 114 and 110. The competitor prices publicly available may be derived by scanning through the internet. For obtaining the competitor's price value for the dairy-related products 136A-N from the one or more data sources, the best suitable price determination subsystem 128 is configured for obtaining competitor's market coupons associated with the dairy-related products 136A-N from the one or more data sources. Further, the best suitable price determination subsystem 128 is configured for identifying attributes of the obtained competitor's market coupons using image recognition techniques. For example, any known image recognition techniques such as OCR, may be used. Further, the best suitable price determination subsystem 128 is configured for training a machine learning model to recognize most relevant competitor's market coupon for the dairy-related products 136A-N. This mechanism of acquiring, comparing and grading competitor prices is accurate and faster compared to conventional mechanisms which is tedious and cumbersome.

Further, the best suitable price determination subsystem 128 is configured for determining at least one price value among the generated optimum price value, the computed average price value and the competitor's price value for the dairy-related products 136A-N that matches with pre stored assessment criteria. The pre-stored criteria may include organization budget, feasibility, stock analysis, manufacture speed and the like. Furthermore, the best suitable price determination subsystem 128 is configured for selecting the at least one price value matching the pre-stored assessment criteria as the best suitable price value for the dairy-related products 136A-N. For example, say optimum price value matches with the pre-stored criteria, then the optimum price value is selected as the best suitable price value. In a case where none of the generated optimum price value, the computed average price value and the competitor's price value matches with the pre-stored criteria, a new price value is computed using the generated optimum price value, the computed average price value and the competitor's price value, such that the new price value more less matches with the assessment criteria.

The plurality of subsystem further includes a simulation subsystem 130 configured for simulating the determined best suitable price value for the dairy-related products 136A-N in a simulation environment using one or more artificial intelligence-based models. The simulation environment comprises a similar setup as that of the real-world scenario comprising all components and configurations. In a preferred embodiment, the simulated environment may be a virtual environment. In simulating the determined best suitable price value for the dairy-related products 136A-N in a simulation environment using one or more artificial intelligence-based models, the simulation subsystem 130 is configured for generating one or more virtual instances of the dairy-related products 136A-N with the best suitable price value. Further, the simulation subsystem 130 is configured for generating an artificial intelligence-based price performance model of the dairy-related products 136A-N based on the generated one or more virtual instances. The artificial intelligence-based price performance model of the dairy-related products 136A-N represents a correlation between the best suitable price value with one or more performance attributes. A cognitive learning based artificial intelligence model may be used for this purpose. For example, natural language processing-based simulation may be performed. In an embodiment, unsupervised machine learning models may be used to derive intelligent segmentation by demographics, behavioural aspects of customer data. The performance attributes may include impact on sales volume, impact on revenue, and the like. Further, the simulation subsystem 130 is configured for simulating the one or more virtual instances of the dairy-related products 136A-N in a simulation environment based on the generated artificial intelligence-based price performance model of the dairy-related products 136A-N

The simulation subsystem 130 allows re-simulation of the prices to narrow down to exact problem areas of the product sales. The results of the simulation subsystem may also provide graphical reports depicting root causes of the problem areas.

Further, the plurality of subsystem further includes a final price generator subsystem 132 configured for generating a final price value for the dairy-related products 136A-N based on the results of the simulation subsystem. The final price value is the simulated best suitable price value of the dairy-related products 136A-N. The results of the simulation subsystem are indicative of the behaviour of the best suitable price applied into real world scenario. The simulation results may be negative, indicating that the best suitable price determined is not reliable or accurate enough for the current real-world scenario. On the other hand, the simulation result may be positive indicating that the best suitable price determined is much more reliable and accurate for the current real-world scenario. Further, the final price generator subsystem 132 is configured for periodically monitoring changes in the optimum price value, the computed average price value and the competitor's price value for the dairy-related products 136A-N. The final price generator subsystem 132 receives the changes for example on day-to-day basis. This period may be user define which is customizable. Further, the final price generator subsystem 132 continuously analyses customer reviews or feedback, extracts aspects and measure customer sentiment. Further, the final price generator subsystem 132 is configured for generating an updated final price value of the dairy-related products 136A-N based on the monitored changes in the optimum price value, the computed average price value and the competitor's price value for the dairy-related products 136A-N.

Furthermore, the plurality of subsystems includes an output subsystem 134 configured for outputting the generated final price value for the dairy-related products 136A-N on a user interface 108 of a user device 106. The output subsystem 134 may display the generated final price value of the dairy-related products 136A-N as a graphical view or a report view. The output subsystem 134 provides immersive diagnostics of maintenance activities.

The storage unit 114 stores the information relating to the dairy-related products 136A-N and other related information. The storage unit 114 is, for example, a structured query language (SQL) data store. The storage unit 114 is configured as cloud-based database implemented in the cloud computing environment 100, where software application are delivered as a service over a cloud platform. The storage unit 114, according to another embodiment of the present disclosure, is a location on a file system directly accessible by the plurality of subsystems. The storage unit 114 is configured to store supply chain attributes, current demand value, optimum price value, average price value, best suitable price value, competitor's price value, final price value, all the machine learning models, regional product information, market analysis data and the like.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure is not being depicted or described herein. Instead, only so much of a computing system 102 as is unique to the present disclosure or necessary for an understanding of the present disclosure is depicted and described. The remainder of the construction and operation of the computing system 102 may conform to any of the various current implementation and practices known in the art.

Embodiments of the present system and methods are concentrated on estimating pricing for products for recurring effects on prices (e.g., seasonality). The present disclosure concentrates on scenarios when effects on prices are recurring and not for singular events. Other embodiments are possible and are not limited by the examples disclosed herein.

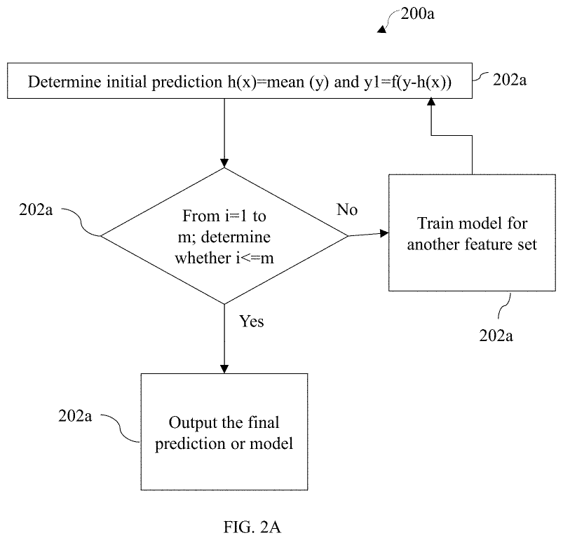

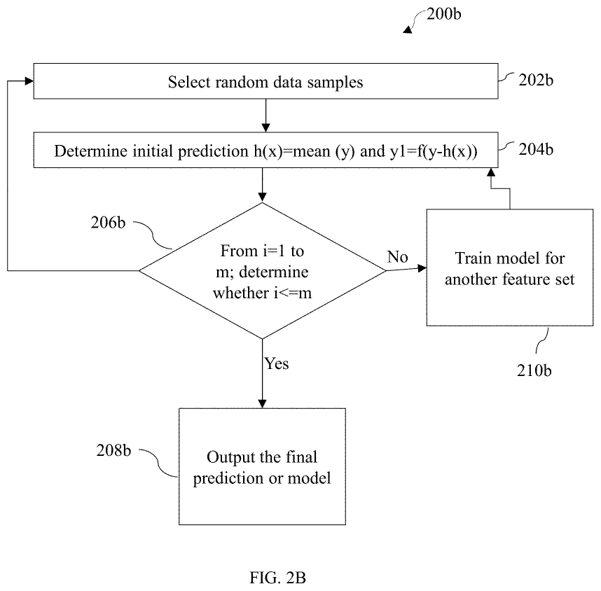

FIG. 2A is a process flow diagram illustrating an exemplary method 200a of decision tree implementation for predicting prices for commodities in accordance with an embodiment of the present disclosure. This method 200a includes a description of the working of decision trees and RF regressors. The decision trees are used to best split the dataset into smaller subsets to predict prices for commodities. The following established model of decision trees is used to predict prices for commodities:

Given training vectors xi ∈| Rⁿ, i=1, . . . 1 and a label vector y ∈| R¹, a decision tree recursively partitions the feature space such that the samples with the same labels or similar target values are grouped together. Let the data at node m be represented by Qₘ with Nₘ samples. For each candidate split θ=(j, tₘ) consisting of a feature j and threshold tₘ, partition the data into Qₘ^{left} (θ)and Qₘ^{right} (θ) subsets:

Qₘ^{left}(θ)={(x,y)|x_{j<=}tₘ}

Qₘ^{right}(θ)=QₘQₘ^{left}(θ)

The quality of a candidate split of node m is then computed using an impurity function or loss function HO, the choice of which depends on the task being solved (classification or regression)

$$G ( {Q}_{m} , θ ) = \frac{{N}_{m}^{left}}{{N}_{m}} H ( {Q}_{m}^{left} ( θ ) ) + ) = \frac{{N}_{m}^{right}}{{N}_{m}} H ( {Q}_{m}^{left} ( θ ) )$$

Further, those parameters that minimizes the impurity are selected:

θ*=argmin_{θ}G(Qₘ,θ)

The subsets Qₘ^{left} (θ*) and Qₘ^{right} (θ*) are recursed until the maximum allowable depth is reached, Nₘ<minₛₐₘₚₗₑₛ, or Nₘ=1.

As disclosed herein, the present disclosure fits the general formula where thresholding functions (entropy, mean, median, etc.) are identified by the nature of feature values. After the target is identified, there is a continuous value so for node m, a common criteria is to minimize to determine future locations to split. These future locations are evaluated using one or more techniques, including mean squared error, Poisson deviance, or mean absolute error.

The random forest method implementation is used to construct many individual decision trees at training, including predictions from all trees were pooled to make the final prediction, the mode of the classes for classification or the mean prediction for regression and random sampling of data is used.

At step 202a, an initial prediction h(x)=mean (y) and y1=f(y−h(x)) is determined. X, Y are combinations of dataset and M is number of iterations till convergence or max depth. H(x) is the mean of predicted price y; and y1 is the associated root mean square. The y1 is used to improve accuracy of the predicted price. At step 204a, from i=1 to m, it is determined whether i<=m. If i<=m, then at step 206a, the final prediction or model is outputted. This means that maximum depth is reached or converged. If not, then at step 208a, model is trained for another feature set and the loop is fed back to step 202a.

FIG. 2B is a process flow diagram illustrating an exemplary method 200b of random forest implementation for predicting prices for commodities in accordance with an embodiment of the present disclosure. Due to the large number of internal and external variables that impacted the accuracy of prediction, it is very useful to reduce number of features to use during model training by evaluating their importance towards target. Feature importance is calculated as the decrease in node impurity weighted by the probability of reaching that node. The node probability is calculated by the number of samples that reach the node, divided by the total number of samples. The higher the value the more important the feature.

At step 202b, random data samples are selected. At step 204b, an initial prediction h(x)=mean (y) and y1=f(y-h(x)) is determined. X, Y are combinations of dataset and M is number of iterations till convergence or max depth. At step 206b, from i=1 to m, it is determined whether i<=m. If i<=m, then at step 208b, the final prediction or model is outputted. This means that weighted average or scoring cross all predictions is completed. If not, then at step 2010b, model is trained for another feature set and the loop is fed back to step 204b. Further, in case if i<=m, which means the maximum depth is reached or converged, then the loop is further fed back to step 202b.

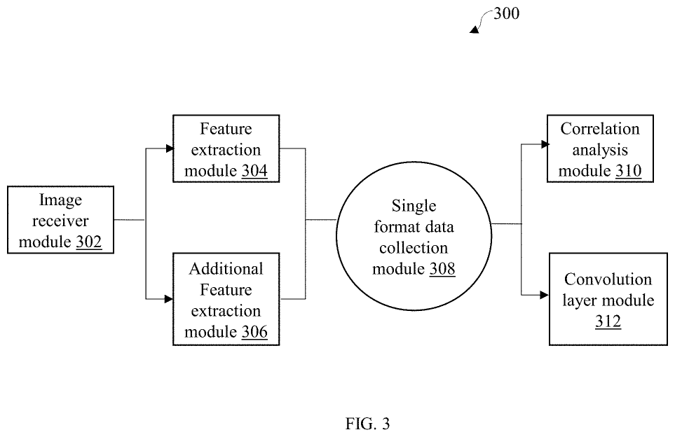

FIG. 3 is a process flow diagram illustrating an exemplary method 300 of high-level image processing using convolution layers in accordance with an embodiment of the present disclosure. The image receiver module 302 collects images as inputs. The feature extraction module 304 and additional feature extraction module 306 extracts main features and additional features of the images. In convolution architecture, multiple dimensions of features gets collected using convolution layer. Maxpooling layer helps in down-sampling after convolution layers (it helps in cases of over-fitting). Fully connected architecture helps in reconciling all feature sets towards a regression prediction. Below is further details of how image recognition works. Various features of coupons are extracted such as image features (for example, pixel colors), image to text features such as package dimensions, brand name, product information (ingredients, quantity, per unit price), expiry information, other brands identification, and inventory features such as sale stats, average expiry duration, stock stats, and date information. The extracted main features and additional features are then fed to single format data collection module 308 to convert the extracted main features and additional features into a single format. The output of the image recognition and processing are correlation features or changes between coupon or non-coupon products and analysis from different dimensions (e.g., other brand promotion, packaging changes and the like produced by correlation analysis module 310. Further, the convolution layer module 312 generates prediction for coupons and number prediction.

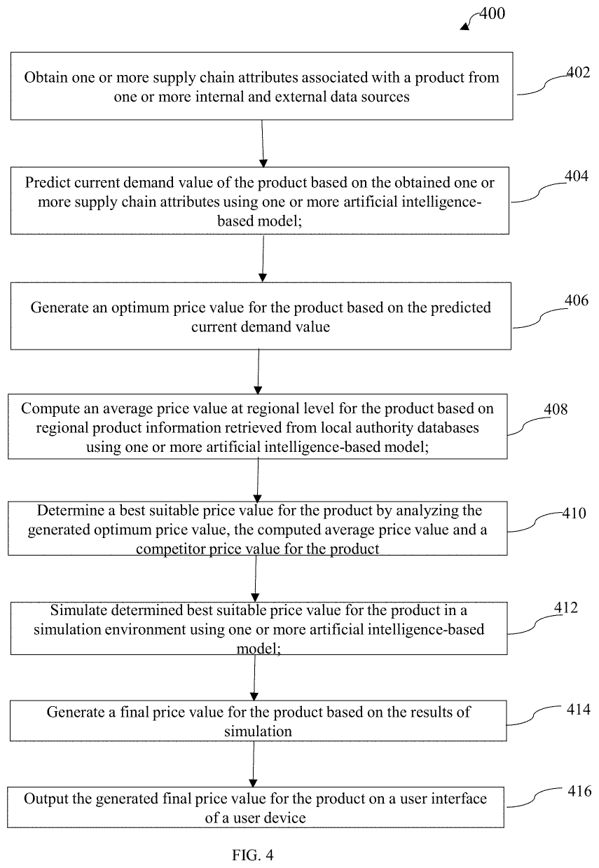

FIG. 4 is a process flow diagram illustrating an exemplary method 400 for predicting prices for commodities in accordance with an embodiment of the present disclosure. At step 402, one or more supply chain attributes associated with a dairy-related products 136A-N are obtained from one or more internal and external data sources 114 and 110. At step 404, current demand value of the dairy-related products 136A-N is predicted based on the obtained one or more supply chain attributes using one or more artificial intelligence-based models. At step 406, an optimum price value for the dairy-related products 136A-N is generated based on the predicted current demand value. At step 408, the average price value at a regional level for the dairy-related products 136A-N is computed based on regional product information retrieved from one or more local authority databases using one or more artificial intelligence-based models. At step 410, a best suitable price value for the dairy-related products 136A-N is determined by analysing the generated optimum price value, the computed average price value and a competitor's price value for the dairy-related products 136A-N. At step 412, the determined best suitable price value for the dairy-related products 136A-N is simulated in a simulation environment using one or more artificial intelligence-based models. At step 414, a final price value for the dairy-related products 136A-N is generated based on the results of the simulation subsystem. The final price value is the simulated best suitable price value of the dairy-related products 136A-N. At step 416, the generated final price value for the dairy-related products 136A-N is outputted on a user interface 108 of a user device 106.

In predicting the current demand value of the dairy-related products 136A-N based on the obtained one or more supply chain attributes using the one or more artificial intelligence-based models, the method 400 includes classifying the one or more supply chain attributes based on the content and type of the one or more supply chain attributes. The method 400 further includes generating a supply chain artificial intelligence model based on the classified one or more supply chain attributes. The supply chain artificial intelligence model represents a correlation between each of the one or more supply chain attributes. The method 400 includes predicting the current demand value of the dairy-related products 136A-N based on the generated supply chain artificial intelligence model.

In generating the optimum price value for the dairy-related products 136A-N based on the predicted current demand value, the method 400 includes determining product market analysis data associated with the dairy-related products 136A-N based on the predicted demand value. The product market analysis data comprises macroeconomics data, microeconomics data, environmental data, customer base data, event occurrence data, financial data, transactional data, demographics data, local authority data and market promotional data. The method 400 includes computing product price elasticity value for the dairy-related products 136A-N based on the determined product market analysis data. The method 400 further includes generating optimum price value for the dairy-related products 136A-N based on the computed product elasticity value for the dairy-related products 136A-N.

In computing the average price value at a regional level for the dairy-related products 136A-N based on regional product information retrieved from one or more local authority databases, to include, but not limited to, data published by the United States Department of Agriculture (USDA) that is comprised of a weekly list of average daily prices of products. The regional pricing information can also include using one or more artificial intelligence-based models. The method 400 also includes retrieving regional product information associated with the dairy-related products 136A-N from one or more local authority databases. The regional product information comprises market promotional data, and net average price of the dairy-related products 136A-N as directed by the local authority guidelines. The method 400 further includes generating an artificial intelligence based regional price model based on the retrieved regional product information. The generated artificial intelligence based regional price model represents a correlation between each of the regional product information associated with the dairy-related products 136A-N. The method 400 includes computing the average price value at a regional level for the dairy-related products 136A-N based on the generated artificial intelligence based regional price model.

In determining a best suitable price value for the dairy-related products 136A-N by analysing the generated optimum price value, the computed average price value and the competitor's price value for the dairy-related products 136A-N, the method 400 includes obtaining the competitor's price value for the dairy-related products 136A-N from one or more data sources. The method 400 includes determining at least one price value among the generated optimum price value, the computed average price value and the competitor's price value for the dairy-related products 136A-N that matches with pre stored assessment criteria. The method 400 includes selecting the at least one price value matching the pre-stored assessment criteria as the best suitable price value for the dairy-related products 136A-N.

In obtaining the competitor's price value for the dairy-related products 136A-N from the one or more data sources, the method 400 includes obtaining competitor's market coupons associated with the dairy-related products 136A-N from the one or more data sources. The method 400 includes identifying attributes of the obtained competitor's market coupons using image recognition techniques. According to some embodiments, Image recognition techniques include a combination of OCR, object detection, and deep learning of image processing. The method 400 further includes training a machine learning model to recognize most relevant competitor's market coupon for the dairy-related products 136A-N.

In simulating the determined best suitable price value for the dairy-related products 136A-N in a simulation environment using one or more artificial intelligence-based models, the method includes generating one or more virtual instances of the dairy-related products 136A-N with the best suitable price value. The method 400 includes generating an artificial intelligence-based price performance model of the dairy-related products 136A-N based on the generated one or more virtual instances. The artificial intelligence-based price performance model of the dairy-related products 136A-N represents a correlation between the best suitable price value with one or more performance attributes. The method 400 includes simulating the one or more virtual instances of the dairy-related products 136A-N in a simulation environment based on the generated artificial intelligence-based price performance model of the dairy-related products 136A-N.

The method 400 includes periodically monitoring changes in the optimum price value, the computed average price value and the competitor's price value for the dairy-related products 136A-N. Further, the method 400 includes generating an updated final price value of the dairy-related products 136A-N based on the monitored changes in the optimum price value, the computed average price value and the competitor's price value for the dairy-related products 136A-N.

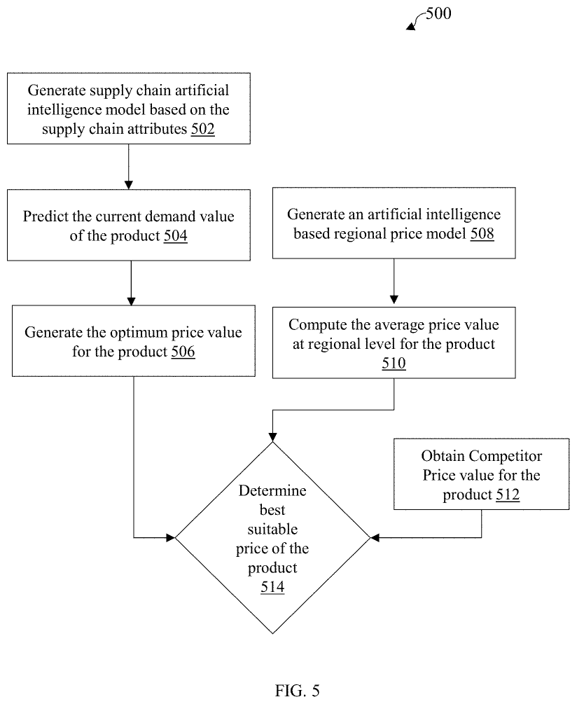

FIG. 5 is a process flow diagram illustrating an exemplary method 500 for determining best suitable price of the dairy-related products 136A-N in accordance with an embodiment of the present disclosure. At step 502, supply chain artificial intelligence model is generated based on the supply chain attributes. The supply chain artificial intelligence model represents a correlation between each of the one or more supply chain attributes. At step 504, the current demand value of the dairy-related products 136A-N is predicted based on the generated supply chain artificial intelligence model. At step 506, the optimum price value for the dairy-related products 136A-N is generated based on the predicted current demand value. At step 508, an artificial intelligence based regional price model is generated based on the retrieved regional product information. The generated artificial intelligence based regional price model represents a correlation between each of the regional product information associated with the dairy-related products 136A-N. At step 510, the average price value at a regional level for the dairy-related products 136A-N is computed based on the generated artificial intelligence based regional price model. At step 512, the competitor's price value for the dairy-related products 136A-N is obtained from one or more data sources. At step 514, at least one price value among the generated optimum price value, the computed average price value and the competitor's price value for the dairy-related products 136A-N that matches with pre stored assessment criteria is determined. The at least one price value matching the pre-stored assessment criteria is then selected as the best suitable price value for the dairy-related products 136A-N.

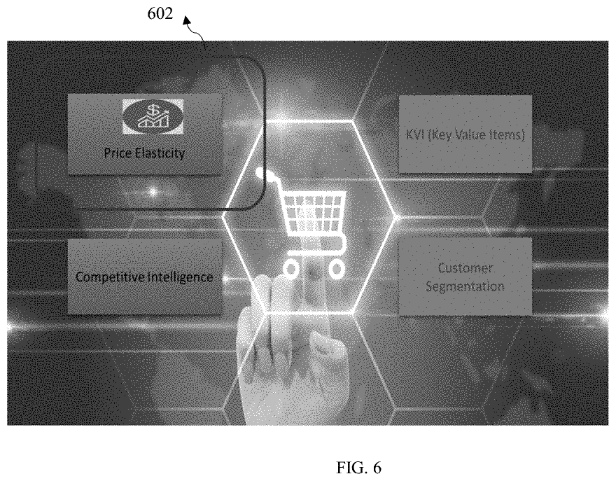

FIG. 6 is a snapshot view of an exemplary graphical user interface depicting a launch page of the software application, in accordance with an embodiment of the present disclosure. The launch page comprises components such as price elasticity 602, key value items, competitive intelligence, and customer segmentation.

Various embodiments of the present system provide a technical solution to the problem of setting prices to food products which are typically impacted by many variables. This system helps in setting prices intelligently i.e., neither too high (that erodes market share) nor too low (that erodes profitability). The present system helps in finding the right trade-offs between multiple variables of demand & supply, customer behaviour, competitor price setting behaviours. The present system provides a data driven approach and brings all of the information that a pricing manager would need to make an informed and intelligent decision quickly.

The present system helps retail store managers with a data driven and intelligent system to set ‘retail prices’ for the food prices. The overall solution helps in comparing of various price factors that typically a pricing manger uses to make a decision. The present system uses various parameters such as store demand, local events, gas prices, historical prices as input parameters and applies machine learning algorithms to arrive at a certain predicted price P1. The system uses periodically published regional prices from USDA to derive regional average prices P2. The system also scans the internet for competitor prices on a daily basis— P3. The system provides a visual rendering of P1, P2 versus P3 that helps the pricing manager to arrive at a quick decision.

The present artificial intelligence-based solution leverages natural language processing to explain how the AI solution is actually performing the calculations and recommendations. At every step of prediction, detection, simulation and automation, the system provides clear answers to most relevant questions in easy-to-understand language. Further, the present system makes intelligent price predictions local to a zip code. The present system considers a variety of internal, external and local data (events, weather, and the like) to arrive at prices that are very specific to a zip-code. Also, the present system detects market promotions detection in an area. Further, the present system provides instant simulation of prices, revenue and demand By simulating changes to supply chain parameters and market analysis data, the system simulates the impact of price changes on revenue and demand which can drive decisions. Furthermore, the present system allows the price changes to be automatically incorporated in to pricing systems.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address the unresolved problem of accurately forecasting demand for a retail organization without human intervention. The embodiment thus provides a platform which automates the process of prediction of sales forecast.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for performing context-based application disablement on an electronic device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

We claim:

1. A system for predicting prices for commodities in a computing environment, the system comprising:
one or more hardware processors; and
a memory coupled to the one or more hardware processors, wherein the memory comprises a plurality of subsystems in the form of programmable instructions executable by the one or more hardware processors, and wherein the plurality of subsystems comprises:
a supply chain attribute collection subsystem configured for obtaining one or more supply chain attributes associated with a product from one or more internal and external data sources;
a demand value prediction subsystem configured for predicting a current demand value of the product based on the obtained one or more supply chain attributes using one or more artificial intelligence-based models;
an optimum price value generator subsystem configured for generating an optimum price value for the product based on the predicted current demand value;
an average price value computing subsystem configured for computing an average price value at a regional level for the product based on regional product information retrieved from one or more local authority databases using one or more artificial intelligence-based models;
a best suitable price determination subsystem configured for determining a best suitable price value for the product by analyzing the generated optimum price value, the computed average price value, and a competitor's price value for the product;
a simulation subsystem configured for simulating the determined best suitable price value for the product in a simulation environment using one or more artificial intelligence-based models;
a final price generator subsystem configured for generating a final price value for the product based on results of the simulation subsystem, wherein the final price value is the simulated best suitable price value of the product; and
an output subsystem configured for outputting the generated final price value for the product on a user interface of a user device.

2. The system of claim 1, wherein in predicting the current demand value of the product based on the obtained one or more supply chain attributes using the one or more artificial intelligence-based models, the demand value prediction subsystem is configured for:
classifying the one or more supply chain attributes based on the content and type of the one or more supply chain attributes;
generating a supply chain artificial intelligence model based on the classified one or more supply chain attributes, wherein the supply chain artificial intelligence model represents a correlation between each of the one or more supply chain attributes; and
predicting the current demand value of the product based on the generated supply chain artificial intelligence model.

3. The system of claim 1, wherein in generating the optimum price value for the product based on the predicted current demand value, the optimum price value generator subsystem is configured for:
determining product market analysis data associated with the product based on the predicted demand value, wherein the product market analysis data comprises at least one of a set containing macroeconomics data, microeconomics data, environmental data, customer base data, event occurrence data, financial data, transactional data, demographics data, local authority data, and market promotional data;
computing a product price elasticity value for the product based on the determined product market analysis data; and
generating an optimum price value for the product based on the computed product elasticity value for the product.

4. The system of claim 1, wherein in computing the average price value at a regional level for the product based on regional product information retrieved from one or more local authority databases using one or more artificial intelligence-based models, the average price value computing subsystem is configured for:
retrieving regional product information associated with the product from one or more local authority databases, wherein regional product information comprises market promotional data, and net average price of the product as directed by the local authority guidelines;
generating an artificial intelligence based regional price model based on the retrieved regional product information, wherein the generated artificial intelligence based regional price model represents a correlation between each of the regional product information associated with the product; and
computing the average price value at a regional level for the product based on the generated artificial intelligence based regional price model.

5. The system of claim 1, wherein in determining a best suitable price value for the product by analyzing the generated optimum price value, the computed average price value, and the competitor's price value for the product, the best suitable price determination subsystem is configured for:
obtaining the competitor's price value for the product from the one or more data sources;
determining at least one price value among the generated optimum price value, the computed average price value, and the competitor's price value for the product that matches with pre-stored assessment criteria; and
selecting the at least one price value matching the pre-stored assessment criteria as the best suitable price value for the product.

6. The system of claim 5, wherein in obtaining the competitor's price value for the product from the one or more data sources, the best suitable price determination subsystem is configured for:
obtaining competitor's market coupons associated with the product from the one or more data sources;
identifying attributes of the obtained competitor's market coupons using image recognition techniques; and
training a machine learning model to recognize a most relevant competitor's market coupon for the product.

7. The system of claim 1, wherein in simulating the determined best suitable price value for the product in a simulation environment using one or more artificial intelligence-based models, the simulation subsystem is configured for:
generating one or more virtual instances of the product with the best suitable price value;
generating an artificial intelligence-based price performance model of the product based on the generated one or more virtual instances, wherein the artificial intelligence-based price performance model of the product represents a correlation between the best suitable price value with one or more performance attributes; and
simulating the one or more virtual instances of the product in a simulation environment based on the generated artificial intelligence-based price performance model of the product.

8. The system of claim 1, wherein the final price generator subsystem is configured for:
periodically monitoring changes in the optimum price value, the computed average price value, and the competitor's price value for the product; and
generating an updated final price value of the product based on the monitored changes in the optimum price value, the computed average price value, and the competitor's price value for the product.

9. The system of claim 1, wherein the product is one of a dairy product or a dairy-based product.

10. A method for predicting prices for one or more commodities in a computing environment, the method comprising:
obtaining, by a processor, one or more supply chain attributes associated with a product from one or more internal and external data sources;
predicting, by the processor, current demand value of the product based on the obtained one or more supply chain attributes using one or more artificial intelligence-based models;
generating, by the processor, an optimum price value for the product based on the predicted current demand value;
computing, by the processor, an average price value at a regional level for the product based on regional product information retrieved from one or more local authority databases using one or more artificial intelligence-based models;
determining, by the processor, a best suitable price value for the product by analyzing the generated optimum price value, the computed average price value, and a competitor's price value for the product;
simulating, by the processor, the determined best suitable price value for the product in a simulation environment using one or more artificial intelligence-based models;
generating, by the processor, a final price value for the product based on the results of the simulation subsystem, wherein the final price value is the simulated best suitable price value of the product; and
outputting, by the processor, the generated final price value for the product on a user interface of a user device.

11. The method of claim 10, wherein predicting the current demand value of the product based on the obtained one or more supply chain attributes using the one or more artificial intelligence-based models comprises:
classifying the one or more supply chain attributes based on the content and type of the one or more supply chain attributes;
generating a supply chain artificial intelligence model based on the classified one or more supply chain attributes, wherein the supply chain artificial intelligence model represents a correlation between each of the one or more supply chain attributes; and
predicting the current demand value of the product based on the generated supply chain artificial intelligence model.

12. The method of claim 10, wherein generating the optimum price value for the product based on the predicted current demand value comprises:
determining product market analysis data associated with the product is based on the predicted demand value, wherein the product market analysis data comprises at least one of a set containing macroeconomics data, microeconomics data, environmental data, customer base data, event occurrence data, financial data, transactional data, demographics data, local authority data, and market promotional data;
computing a product price elasticity value for the product based on the determined product market analysis data; and
generating an optimum price value for the product based on the computed product elasticity value for the product.

13. The method of claim 10, wherein computing the average price value at a regional level for the product based on regional product information retrieved from one or more local authority databases using one or more artificial intelligence-based models comprises:
retrieving regional product information associated with the product from one or more local authority databases, wherein regional product information comprises market promotional data, and net average price of the product as directed by the local authority guidelines;
generating an artificial intelligence based regional price model based on the retrieved regional product information, wherein the generated artificial intelligence based regional price model represents a correlation between each of the regional product information associated with the product; and
computing the average price value at a regional level for the product based on the generated artificial intelligence based regional price model.

14. The method of claim 10, wherein determining a best suitable price value for the product by analyzing the generated optimum price value, the computed average price value and the competitor's price value for the product comprises:
obtaining the competitor's price value for the product from one or more data sources;
determining at least one price value among the generated optimum price value, the computed average price value and the competitor's price value for the product that matches with pre stored assessment criteria; and
selecting the at least one price value matching the pre-stored assessment criteria as the best suitable price value for the product.

15. The method of claim 14, wherein obtaining the competitor's price value for the product from the one or more data sources comprises:
obtaining competitor's market coupons associated with the product from the one or more data sources;
identifying attributes of the obtained competitor's market coupons using image recognition techniques; and
training a machine learning model to recognize most relevant competitor's market coupon for the product.

16. The method of claim 10, wherein simulating the determined best suitable price value for the product in a simulation environment using one or more artificial intelligence-based models comprises:
generating one or more virtual instances of the product with the best suitable price value;
generating an artificial intelligence-based price performance model of the product based on the generated one or more virtual instances, wherein the artificial intelligence-based price performance model of the product represents a correlation between the best suitable price value with one or more performance attributes; and
simulating the one or more virtual instances of the product in a simulation environment based on the generated artificial intelligence-based price performance model of the product.

17. The method of claim 10, further comprising:
periodically monitoring changes in the optimum price value, the computed average price value, and the competitor's price value for the product; and
generating an updated final price value of the product based on the monitored changes in the optimum price value, the computed average price value, and the competitor's price value for the product.

18. A non-transitory computer-readable storage medium having instructions stored therein that when executed by a hardware processor, cause the processor to perform method steps comprising:
obtaining one or more supply chain attributes associated with a product from one or more internal and external data sources;
predicting a current demand value of the product based on the obtained one or more supply chain attributes using one or more artificial intelligence-based models;
generating an optimum price value for the product based on the predicted current demand value;
computing an average price value at a regional level for the product based on regional product information retrieved from one or more local authority databases using one or more artificial intelligence-based models;
determining a best suitable price value for the product by analyzing the generated optimum price value, the computed average price value, and a competitor's price value for the product;
simulating the determined best suitable price value for the product in a simulation environment using one or more artificial intelligence-based models;
generating a final price value for the product based on the results of the simulation subsystem, wherein the final price value is the simulated best suitable price value of the product; and
outputting the generated final price value for the product on a user interface of a user device.

19. The non-transitory computer-readable storage medium of claim 18, wherein the product is one of a dairy product or a dairy-based product.

20. The non-transitory computer-readable storage medium of claim 18, further causing the processor to perform the method steps comprising:
periodically monitoring changes in the optimum price value, the computed average price value, and the competitor's price value for the product; and
generating an updated final price value of the product based on the monitored changes in the optimum price value, the computed average price value, and the competitor's price value for the product.
